(19) United States
(12) Patent Application Publication
(10) Pub. No.: US 2006/0137834 A1
(43) Pub. Date: Jun. 29, 2006

(54) Operating unit

(76) Inventor: Michael Hormann, Oerlingshausen (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 10/543,825

(22) PCT Filed: Jun. 4, 2003
(86) PCT No.: PCT/EP03/05862

§ 371 Date: Nov. 20, 2005

(30) Foreign Application Priority Data
Jan. 30, 2003 (DE) 203 01 439.1

(51) Int. Cl. E06B 9/08

(52) U.S. Cl. 160/133

(57) ABSTRACT

This invention relates to an operating unit for one or more gate, window, door or roller shutter drives. In accordance with the invention, one basic element is provided for each driven gate, window, door or roller shutter. The basic elements each accommodate the operating elements required for operating a gate, window, door or roller shutter drive, and can be joined together.

This invention relates to an operating unit for one or more gate, window, door or roller shutter drives.

Operating units for a garage door drive are known. The same are sold as accessory for garage door drives and mounted on the wall in the interior of the garage. The known operating units accommodate the operating elements required for operating a garage door. The individual operating elements can for instance be designed as push buttons. There is normally provided one operating element for starting and stopping the drive motor, for instance in the form of a start-stop push button. Additional operating elements or push buttons can be provided for the lighting and for electronically blocking the garage door drive.

The known operating units have the disadvantage that in the case of double or multiple gates, windows, doors or roller shutters a plurality of operating units provided for a door drive must be mounted one beside the other. Fitting double or multiple gates, windows, doors or roller shutters with the known operating units therefore involves a complex assembly and leads to solutions of poor aesthetic appearance.

Therefore, it is an object of the present invention to propose an operating unit which can also be realized for double or multiple gates, windows, doors or roller shutters with little assembly effort and in an optically elegant way.

In accordance with the invention, this object is solved in that the operating unit comprises one or more basic elements. In each basic element, the operating elements required for operating a gate are accommodated, i.e. for instance the push buttons “start/stop”, “lighting” and “electronic blocking”. For each of the gates, windows, doors or roller shutters to be operated, one basic element is provided, so that for instance the operating unit for a double gate comprises two basic elements. In accordance with the invention, the basic elements can be joined together, so that in the assembled condition the operator gets the optical appearance of a single operating unit for the entire gate, window, door or roller shutter system.

In accordance with a preferred aspect, all basic elements have the same design. This facilitates the assembly and decreases the production costs. In accordance with another preferred aspect, joining together is effected in that the basic elements are plugged together. For instance, the plug-in connection is made between the vertical side walls of the basic elements, so that in the assembled condition the basic elements are arranged horizontally one beside the other. Preferably, the plug-in connection can be realized in that the basic elements have a recess at one side and an extension at the opposite side. For joining the basic elements together, the extension of one basic element then is plugged into the recess of the adjacent basic element. It is particularly advantageous when in the plugged condition the extension is positively enclosed by the recess. As a result, the extension is comparatively firmly seated in the recess and a comparatively stable and loadable plug-in connection is obtained.

In accordance with another preferred aspect, an end cap is provided as further part of the operating unit. The end cap can be plugged into the terminal basic element, so that the unsightly recess of the terminal basic element is concealed. An even more elegant optical appearance is. achieved by shaping the end cap such that for the viewer it creates the symmetry with the exposed extension located at the other end of the operating unit. To this end, the shape of that part of the end cap, which in its plugged condition is not concealed to the viewer by the basic element, must substantially correspond to the extension located on the opposite side. Thus, the end cap ensures that in the assembled condition the operating unit generally has a symmetric appearance for the viewer and operator.

In accordance with another preferred aspect, one or more fastening means are molded to the end cap. Furthermore, receptacles for the fastening means are provided at the bottom of the recess. For attaching the end cap to the terminal basic element, the fastening means are connected with the receptacles. Advantageously, the fastening means are designed as T-sections which are plugged into receptacles designed as slots.

In accordance with another preferred aspect, the operating unit of the invention comprises a flush housing. In the flush housing, the electronic inner workings of the operating unit can be accommodated. The operating unit with flush socket allows a flat design of basic element and end cap, which can be mounted flush at the wall. As a result, the operating unit stands out only little from the wall surface, which leads to an optically pleasant total appearance. Advantageously, brackets are provided at the flush socket, to which the basic element and/or end cap can be attached, in order to provide the operating unit with more strength and stability.

One embodiment of the invention will subsequently be explained in detail with reference to the attached drawings, in which:

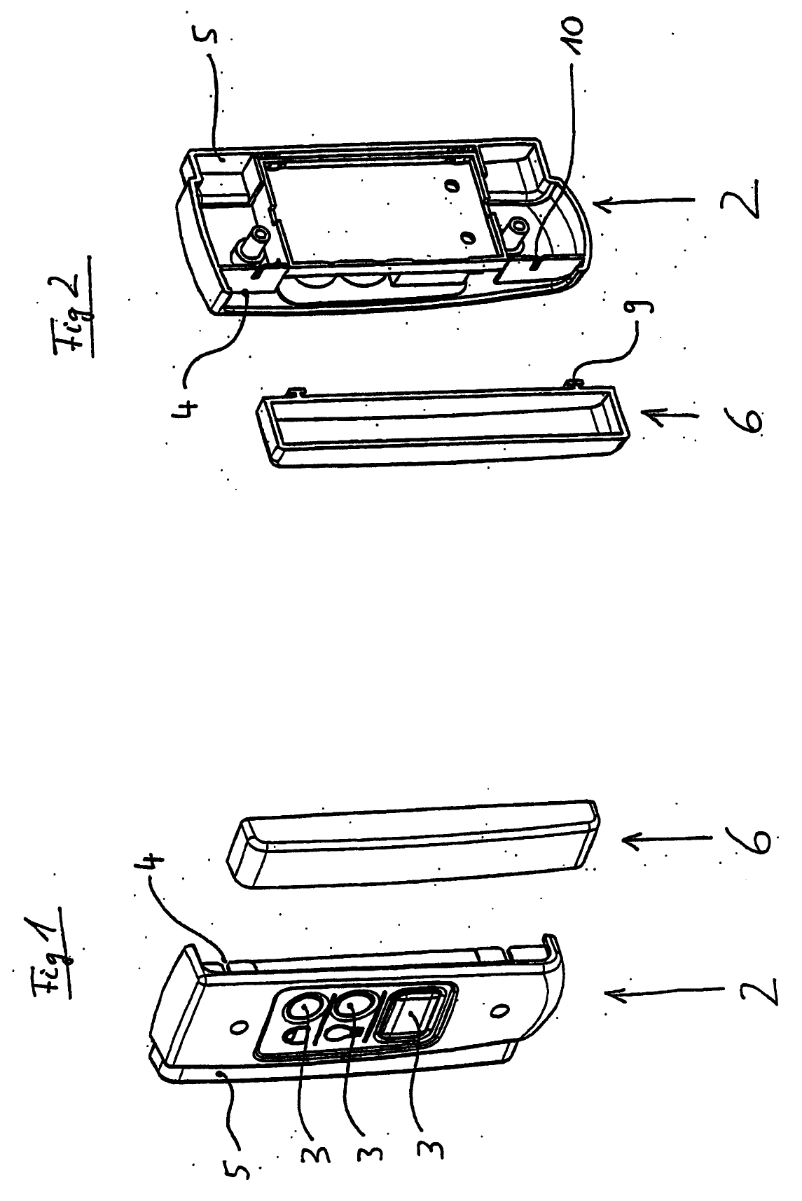

FIG. 1. shows a front view of a basic element 2 and an end cap 6;

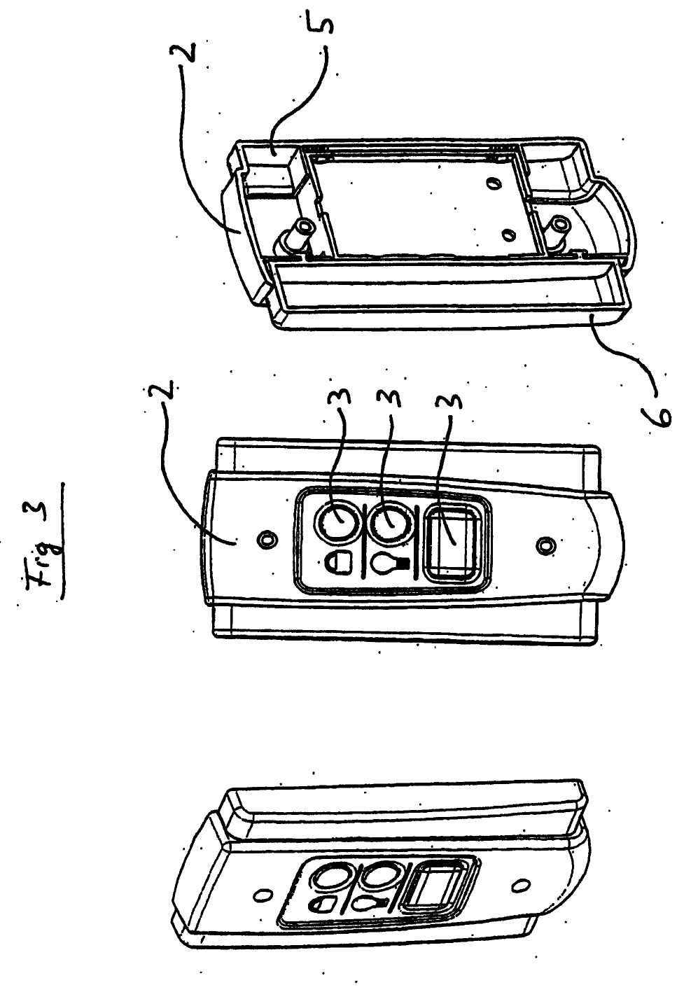

FIG. 2 shows a rear view of a basic element 2 and an end cap 6;

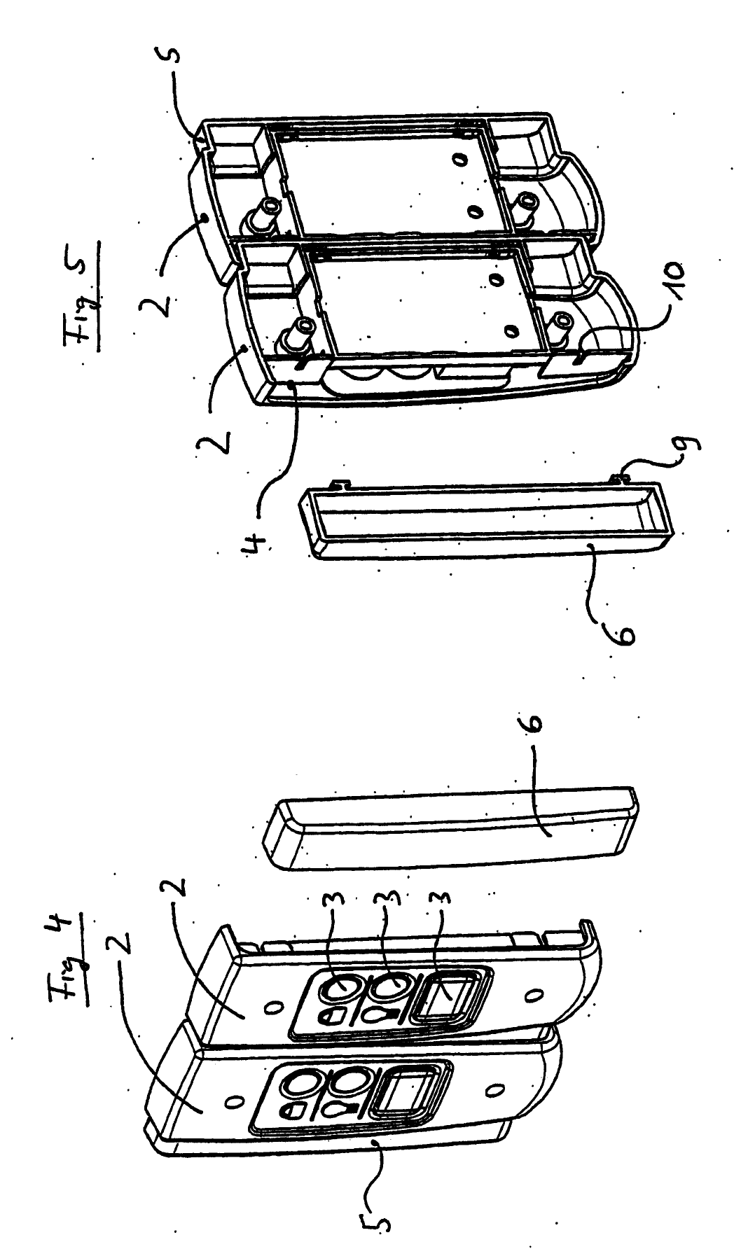

FIG. 3 shows various views of a basic element 2 with inserted end cap 6;

FIG. 4 shows a front view of two basic elements 2 plugged together and of an end cap 6;

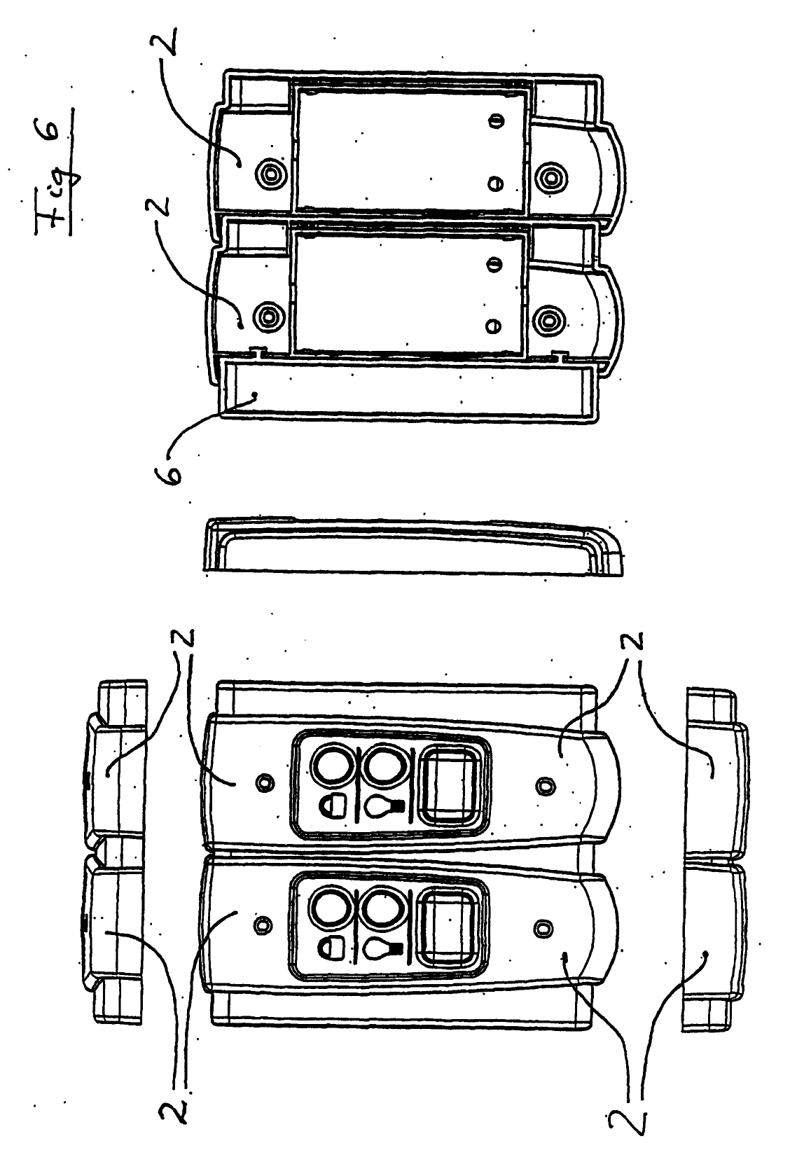

FIG. 5. shows a rear view of two basic elements 2 plugged together and of an end cap 6;

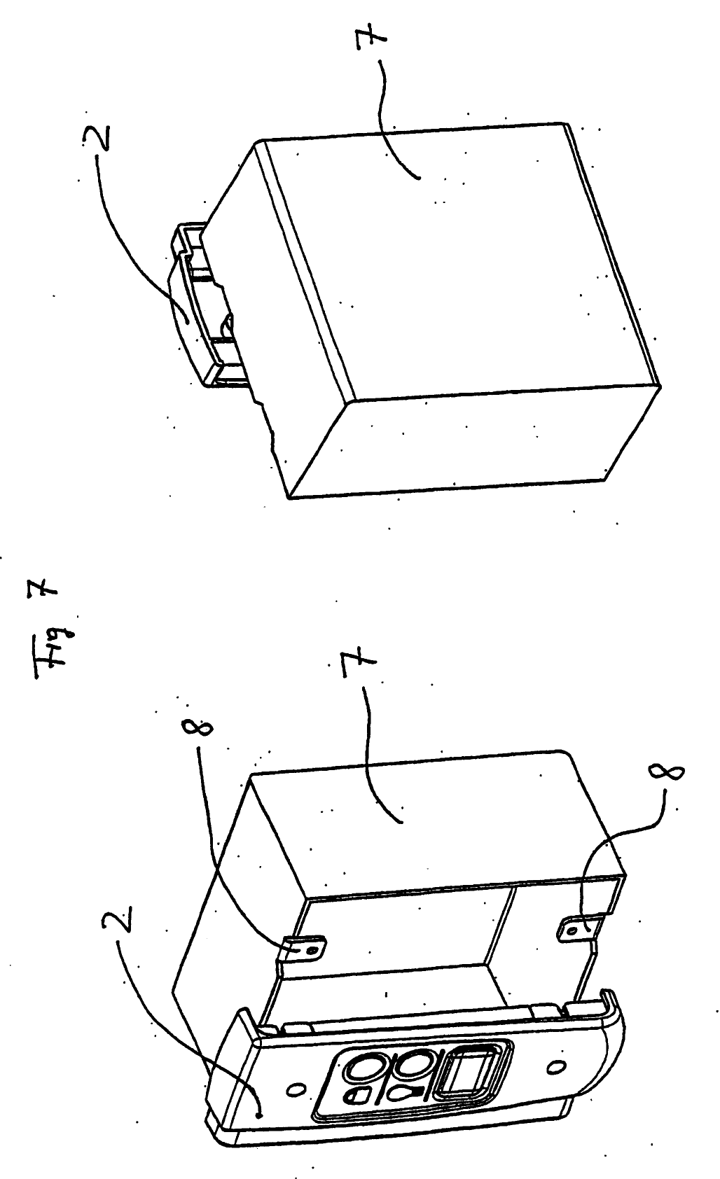

FIG. 6 shows various views of two basic elements 2 plugged together with inserted end cap 6;

FIG. 7 shows front and rear views of a flush socket 7 for two basic elements 2 with a mounted basic element 2; and

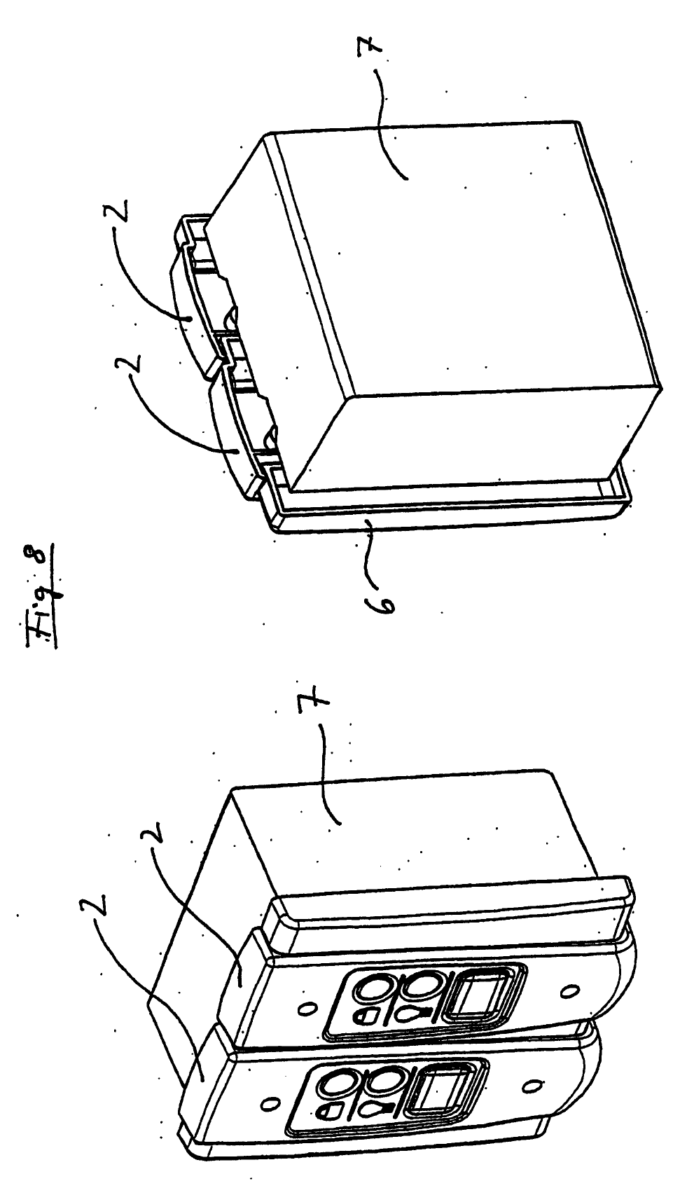

FIG. 8 shows front and rear views of an assembled operating unit with two basic elements 2 and a flush socket 7.

FIG. 1 shows a front view of a basic element 2 and an end cap 6. On the front side of the basic element 2 the operating elements 3 for the gate/door/window/roller shutter operated with this basic element are arranged. In the illustrated embodiment, the operating elements 3 are designed as push buttons. There is each provided one push button for “start/stop”, “lighting”, and “electronic blocking”. On the left side of the basic element the extension 5 is provided, which can be plugged into the recess 4 of an adjacent basic element. Furthermore, FIG. 1 shows the end cap 6, which can be plugged into the recess 4 of a terminal basic element 2. The end cap 6 is designed such that in the plugged condition it provides an appearance corresponding to the projection 5, so that the operating unit as a whole has optically symmetrical ends.

FIG. 2 shows a basic element 2 and an end cap 6 from the rear. On the left side of the basic element 2 a recess 4 is provided, and on the right side the extension 5. At the end cap 6, the T-sections 9 are provided, which are inserted into the slots 10 for mounting the end cap 6 at the basic element 2.

FIG. 3 shows various views of a basic element 2 with inserted end cap 6. The front view in the middle illustrates that the inserted end cap 6 provides an appearance corresponding to the integrally molded extension 5, so that the basic element 2 with inserted end cap 6. generally appears to be symmetrical to the viewer.

FIGS. 4 and 5 show front and rear views of two basic elements 2 plugged together and an end cap 6. On the front side of the two basic elements, the operating elements 3 for one garage door each are provided. FIG. 5 shows how the extension 5 of the left basic element 2 is plugged into the recess 4 of the right basic element 2. The extension 5 is positively enclosed by the edge of the recess 4.

FIG. 6. shows two joined basic elements 2 with an inserted end cap 6. The front view in turn shows that the mounted operating unit is symmetrical to the vertical central plane. The rear view illustrates how end cap 6 and basic element 2 are plugged into each other.

FIG. 7 shows an operating unit with flush socket 7. At the front side of the flush socket 7 brackets 8 are mounted, to which the basic elements 2 can be attached.

FIG. 8 shows that the flush socket 7 is completely covered by the joined basic element and end cap, so that an appearance of high optical quality is achieved. The flush socket is embedded in the wall at which the operating unit is mounted. Thus, only the joined compound of basic element and end cap (2, 6) stands out from the surface of the wall. This leads to a further improvement of the aesthetic appearance of the operating unit.

1. An operating unit for a drive of one or more of a gate, window, door, or roller shutter, comprising:
one basic element for each driven gate, window, door, or roller shutter, each basic element accommodating operating elements required for operating a gate, window, door, or roller shutter drive, and each basic element being configured to be joined together with another basic element.

2. The operating unit as claimed in claim 1, wherein the basic elements have the same structure.

3. The operating unit as claimed in claim 1 wherein the basic elements can be put together.

4. The operating unit as claimed in claim 3 wherein the basic elements are provided with a recess on one side and with an extension on a reverse side, the extension being insertable into the recess of an adjacent basic element.

5. The operating unit as claimed in claim 4 wherein an outside of the inserted extension is positively enclosed by an inside of the recess.

6. The operating unit as claimed in claim 4 further comprising, an end cap which can be plugged into the recess of the basic element.

7. The operating unit as claimed in claim 6 wherein the end cap is shaped such that in its form visible for the user of the mounted operating unit, that part of the end cap which is not concealed by the basic element in the plugged condition substantially corresponds to the extension located on the opposite side.

8. The operating unit as claimed in claim 7 wherein at a side facing the basic element, the end cap has one or more fastening means for mounting the end cap at a terminal basic element which can be connected with receptacles provided in the basic element.

9. The operating unit as claimed in claim 8 wherein the fastening means are designed as T-sections and the receptacles are designed as slots, and the T-sections can be inserted into the slots for mounting the end cap in the basic element.

10. The operating unit as claimed in claim 9 wherein a flush socket is provided, the socket covered by the basic element and end cap joined together when the operating unit is mounted.

11. The operating unit as claimed in claim 10 wherein at the flush socket one or more brackets are provided for mounting the basic element or the end cap.

12. An operating unit, comprising:
a first basic element configured to control a first drive unit of one or more of a first gate, window, door, or roller shutter drives, the first basic element including a first operating element configured to operate the first drive unit; and
a second basic element configured to control a second drive unit of one or more of a second gate, window, door, or roller shutter drives, the second basic element including a second operating element configured to operate the first drive unit;
wherein the first and second basic elements are configured to be joined together.

13. The operating unit of claim 12 wherein the first and second basic elements have a common structure, and wherein the first and second basic elements are configured to be joined together side-by-side.

14. The operating unit of claim 13 wherein each basic element is provided with a recess on one side and with an extension on a reverse side, the extension of the first basic element being insertable into the recess of the second basic element.

15. The operating unit of claim 14, further comprising an end cap which can be plugged into the recess of the recess of the first basic element.

16. An operating unit for a drive of one or more of a gate, window, door, or roller shutter, comprising one modular basic element for each driven gate, window, door, or roller shutter, the basic element accommodating an operating element required for operating a gate, window, door or roller shutter drive, the basic element configured to be joined to another modular basic element, the one basic element and the other basic element having a common structural appearance.
